(19) United States
(12) Patent Application Publication
(10) Pub. No.: US 2021/0181551 A1
(43) Pub. Date: Jun. 17, 2021

(54) LIQUID CRYSTAL DEVICE AND METHOD OF MANUFACTURE THEREFOR

(71) Applicant: JSR CORPORATION, Tokyo (JP)

(72) Inventors: Ryuuzou OONO, Tokyo (JP); Koji KASHISHITA, Tokyo (JP); Yuusuke INOUE, Tokyo (JP); Takahito KATOU, Tokyo (JP); Koichi MIYACHI, Tokyo (JP)

(73) Assignee: JSR CORPORATION, Tokyo (JP)

(21) Appl. No.: 16/338,701

(22) PCT Filed: Sep. 28, 2017
(86) PCT No.: PCT/JP2017/035353

§ 371 Date: Apr. 2, 2019

(30) Foreign Application Priority Data
Oct. 4, 2016 (JP) 2016-196723

(51) Int. Cl. G02F 1/1339; C09K 19/04; G02F 1/1337; G02F 1/1333; G02F 1/1335

(52) U.S. Cl. CPC G02F 1/1339; C09K 19/04; G02F 1/133788; G02F 1/133365; C09K 2019/0448; G02F 1/133514; G02F 1/133707; G02F 2202/022; G02F 1/133512

(57) ABSTRACT

A liquid crystal device 10 includes: a pair of substrates made up of a first substrate 11 and a second substrate 12 arranged facing each other; and a liquid crystal layer 14 interposed between the first substrate 11 and the second substrate 12. The liquid crystal device 10 does not have a liquid crystal alignment film formed on both the first substrate 11 and the second substrate 12. The second substrate 12 has a spacer 15a extending toward the first substrate 11 and the first substrate 11 has a suppressing part for mitigating the misalignment in the liquid crystal layer 14 due to the movement of the tip of the spacer 15s.

### CROSS-REFERENCE TO RELATED APPLICATION

This application claims the priority benefit of Japan application serial no. 2016-196723, filed on Oct. 4, 2016. The entirety of the above-mentioned patent application is hereby incorporated by reference herein and made a part of this specification.

### TECHNICAL FIELD

The present disclosure relates to a liquid crystal device and a method of manufacture therefor.

### BACKGROUND ART

As liquid crystal devices, various liquid crystal devices including liquid crystal devices of a vertical alignment (VA) type in a vertical (homeotropic) alignment mode using a nematic liquid crystal having negative dielectric anisotropy as well as liquid crystal devices in a horizontal alignment mode using a nematic liquid crystal having positive dielectric anisotropy typified by a twisted nematic (TN) type, a super twisted nematic (STN) type, and the like are known. In addition, as a liquid crystal device, there is a liquid crystal device that is designed to keep a constant gap (cell gap) between a TFT substrate and a counter substrate by arranging columnar spacers on a surface of the counter substrate between the pair of substrates and arranging the TFT substrate and the counter substrate to face each other in a state in which the tips of the spacers are in contact with the outermost surface of the TFT substrate.

Generally, a liquid crystal device has a liquid crystal alignment film having the function of aligning liquid crystal molecules in a certain direction. As materials for forming such a liquid crystal alignment film, a polyamic acid, a polyimide, a polyamic acid ester, a polyimide, polyester, a polyorganosiloxane, and the like are known. In particular, liquid crystal alignment films made of a polyamic acid or a polyimide have been preferably used for a long time because they have excellent heat resistance, mechanical strength, affinity with liquid crystal molecules, and the like.

In addition, polymer sustained alignment (PSA) is known as one of alignment processing methods (e.g., refer to Patent Literature 1). PSA is a technique for controlling the initial alignment of a liquid crystal by mixing the liquid crystal and photopolymerizable monomers in advance in the gap between a pair of substrates, and irradiating them with ultraviolet light with a voltage applied between the substrates to polymerize the photopolymerizable monomers, thereby pre-tilt angle characteristics being exhibited. According to this technique, increase in field of view angle and speed of liquid crystal molecule response can be obtained and the problem of insufficient transmissivity and contrast that are unavoidable in multi-domain vertical alignment (MVA) type panels can be solved.

With respect to liquid crystal devices of the PSA type, a method of not providing a liquid crystal alignment film on a surface of each substrate of a pair of substrates has been recently proposed (e.g., refer to Patent Literature 2). Patent Literature 2 discloses a liquid crystal device of the PSA type not having a liquid crystal alignment film in which two or more types of polymerizable monomer are incorporated into a liquid crystal composition and at least one type of the monomer is transformed into monomers having a structure for generating a ketyl radical in a hydrogen abstraction reaction using light irradiation. Accordingly, a liquid crystal display device that is less likely to cause display failure and a decrease in a voltage holding ratio can be obtained.

### CITATION LIST

### Patent Literature

### [Patent Literature 1]

Japanese Patent Laid-Open No. 2003-149647

### [Patent Literature 2]

Japanese Patent Laid-Open No. 2015-99170

### SUMMARY OF INVENTION

### Technical Problem

It is thought that with respect to a liquid crystal device, stress is applied to upper and lower substrates and thus displacement occurs in the width direction (horizontal direction) due to vibration or the like during product transport. In addition, such stress is also assumed to be applied when liquid crystal cells are bent during the manufacture of a curved display having a curved display surface. Here, in a case where displacement of the substrates occurs in the width direction, the tips of the spacers may move in the width direction due to the displacement, and there is concern of misalignment of the liquid crystal occurring at the boundary part between the substrate and the liquid crystal layer due to rubbing of the surface of the TFT substrate on the liquid crystal layer side. In particular, in a configuration with no liquid crystal alignment film formed, since control of initial alignment of a liquid crystal using an organic thin film that has excellent mechanical strength is not performed, initial alignment may not be determined and misalignment may easily occur.

The present disclosure has been made in view of the aforementioned problems and has objectives, one of which is to provide a liquid crystal device that can mitigate the occurrence of misalignment even when stress is applied to upper and lower substrates and displacement occurs in a width direction.

### Solution to Problem

The present disclosure has employed the following means to solve the above-described problems.

The present disclosure relates to a liquid crystal device including a pair of substrates made up of a first substrate and a second substrate arranged to face each other and a liquid crystal layer interposed between the first substrate and the second substrate. According to an aspect, no liquid crystal alignment film is formed on either the first substrate or the second substrate, a spacer extending toward the first substrate is formed on the second substrate, and a suppressing part mitigating misalignment of the liquid crystal layer caused by movement of a tip of the spacer is provided on the first substrate.

According to the above-described configuration, even in a situation in which stress is applied to the upper and lower substrates and displacement occurs in the width direction, it is possible to mitigate misalignment of the liquid crystal at the boundary parts between the substrates and the liquid crystal layer. Accordingly, misalignment can be mitigated and better display quality can be obtained.

According to an aspect of the present disclosure, the liquid crystal layer may be formed using a liquid crystal composition containing photopolymerizable monomers and have a polymer layer obtained by polymerizing the photopolymerizable monomers at the boundary part with respect to each of the pair of substrates.

In a PSA method in which a liquid crystal layer is formed using a liquid crystal composition containing photopolymerizable monomers, a liquid crystal cell is created, and then the liquid crystal cell is irradiated with light with the liquid crystal in an initial alignment state, with layers that impart initial alignment (which will also be referred to as a “PSA layer”) to the liquid crystal formed of photopolymerizable monomers being provided at the boundary parts between the liquid crystal layer and the substrates. Here, the PSA layer is formed using photopolymerization after the creation of the liquid crystal cell and is physically vulnerable in comparison to a liquid crystal alignment film that is formed using a polymer composition obtained by dispersing or dissolving polymers such as a polyamic acid or polyimide in a solvent. Thus, in the case where stress is applied to the upper and lower substrate and displacement occurs in the horizontal direction, the tips of the spacers formed on the surface of the counter substrate are displaced in the horizontal direction, the PSA layers formed at the boundary parts between the substrates and the liquid crystal layer are partially separated, and thus there is concern of occurrence of misalignment. From this viewpoint, according to a configuration in which the technology is applied to a PSA-type liquid crystal device, even in the case where stress is applied to the upper and lower substrates and displacement occurs in the horizontal direction, it is possible to prevent the PSA layers from being separated. Accordingly, misalignment can be mitigated.

According to an aspect of the present disclosure, the liquid crystal layer is formed using the liquid crystal composition containing photopolymerizable monomers and has the polymer layer obtained by polymerizing the photopolymerizable monomers at the boundary part with respect to each of the pair of substrates, and the suppressing part is in contact with the tips of the spacers on the second substrate side or the first substrate side of the polymer layer.

Specifically, as an aspect, a spacer formed on the second substrate is set as a first spacer, the suppressing part is formed at a position on the first substrate facing the first spacer and is a second spacer extending toward the second substrate, and a cell gap is formed by bringing the tip of the first spacer in contact with the tip of the second spacer. In this case, the tips of the spacers can be set not to be in contact with the surfaces of the substrates since the tips of the spacers are arranged at an intermediate position between the pair of substrates.

In addition, a width of the first spacer may be set to be different from a width of the second spacer at a contact part between the first spacer and the second spacer. According to this configuration, even when stress is applied to the upper and lower substrates and displacement occurs in the horizontal direction, a state in which the end faces of the substrates are in contact can be easily maintained and resistance to shearing stress can be increased.

In addition, as another aspect, the first substrate may be a TFT substrate, the second substrate may be a counter substrate that is arranged to face the TFT substrate, the suppressing part may be a projecting part projecting in the direction facing the counter substrate, a cell gap may be formed by bringing a tip of the projecting part in contact with the tip of the spacer, and the projecting part may be formed using the same material as a material constituting at least one type selected from a group consisting of a thin film transistor, a pixel electrode, wiring, and an insulating layer included in the TFT substrate

In addition, as another aspect, the second substrate may be a TFT substrate, the first substrate may be a counter substrate that is arranged to face the TFT substrate and has a light shielding layer and a color filter layer, the suppressing part may be a projecting part projecting in the direction facing the TFT substrate, a cell gap may be formed by bringing a tip of the projecting part in contact with the tip of the spacer, and the projecting part may be formed of a laminated body of the light shielding layer and the color filter layer or the light shielding layer.

According to an aspect of the present disclosure, a resin layer not having a liquid crystal aligning capability may be formed on the first substrate, the suppressing part may be a recess part formed at a position on the resin layer facing the spacer to be recessed to the side opposite to the direction facing the second substrate, and a cell gap may be formed by bringing a bottom of the recess part in contact with the tip of the spacer. In this case, by causing the tip of the spacer to fit into the recess part, a state in which the end faces of the two parts are in contact can be easily maintained and resistance to shearing stress can be increased even when stress is applied to the upper and lower substrates and thus displacement occurs in the horizontal direction, which is favorable.

According to an aspect of the present disclosure, the spacer may be formed to have the same length as a gap between the first substrate and the second substrate in a region in which the spacers are not arranged, and the suppressing part may be a projecting part arranged on the first substrate on an outer circumferential side of the spacer and projecting toward the counter substrate. Specifically, in this case, the first substrate may be a TFT substrate, the second substrate may be a counter substrate arranged to face the TFT substrate, and the projecting part may be formed using the same material as a material constituting at least one type selected from a group consisting of a thin film transistor, a pixel electrode, wiring, and an insulating layer included in the TFT substrate. Alternatively, the second substrate may be a TFT substrate, the first substrate may be a counter substrate arranged to face the TFT substrate and have a light shielding layer and a color filter layer, and the projecting part may be formed of a laminated body of the light shielding layer and the color filter layer or the light shielding layer.

According to an aspect of the present disclosure, a layer comprising a water-soluble compound [B] having at least one of a linear alkyl structure having three or more carbon atoms and an alicyclic structure may be formed on the liquid crystal layer side of at least one of the first substrate and the second substrate. By arranging the layer composed of the water-soluble compound [B] on the surface of the liquid crystal layer side of the substrate not having a liquid crystal alignment film, stability of initial alignment and a voltage holding ratio can be further improved. In addition, as the water-soluble compound [B], a compound having at least one type of functional group selected from a group consisting of a vinyl group, an epoxy group, an amino group, a (meth)acryloyl group, a mercapto group, and an isocyanate group is preferably included. By having at least one of these functional groups, stability of initial alignment and a voltage holding ratio can be further improved, which is favorable.

The liquid crystal layer may have negative dielectric anisotropy. In this case, even in a case where stress is applied to the upper and lower substrates and displacement occurs in the horizontal direction, a liquid crystal device of a vertical alignment type in which misalignment is less likely to occur can be obtained.

An aspect of the present disclosure is a method of manufacturing a liquid crystal device including a pair of substrates made up of a first substrate and a second substrate arranged to face each other and a liquid crystal layer interposed between the first substrate and the second substrate, not having a liquid crystal alignment film formed on either the first substrate or the second substrate, and the method includes a step of forming a spacer extending away from a surface of the second substrate on the second substrate, a step of forming a suppressing part mitigating misalignment of the liquid crystal layer on the first substrate, which is caused by movement of a tip of the spacer in the liquid crystal device, a step of creating a liquid crystal cell by arranging the first substrate and the second substrate to face each other via a layer of a liquid crystal composition containing photopolymerizable monomers so that the movement of the spacer is restricted by the suppressing part, and a step of irradiating the liquid crystal cell with light.

The above-described method of manufacture may further include a step of forming a layer comprising a water-soluble compound [B] having at least one of a linear alkyl structure having three or more carbon atoms and a monocyclic or polycyclic alicyclic structure on at least one of the first substrate and the second substrate.

In addition, a step of dropping the liquid crystal composition on one of the first substrate and the second substrate using an inkjet coating device may be further included. Alternatively, a step of dropping the liquid crystal composition on one of the first substrate and the second substrate using a liquid crystal dropping device such that the distance between dropping points of liquid droplets is 3 mm or less may be included.

### BRIEF DESCRIPTION OF DRAWINGS

The aforementioned objective, other objectives, characteristics, and advantages of the present disclosure will be further clarified by the following detailed description with reference to the accompanying drawings.

FIG. 1 is a cross sectional view of a liquid crystal device according to a first embodiment.

FIG. 2 is an enlarged cross sectional view of a spacer part.

FIG. 3 is a cross sectional view showing a method of manufacture for the liquid crystal device.

FIG. 4 is an enlarged cross sectional view of a spacer part of a liquid crystal device according to a second embodiment.

FIG. 5 is an enlarged cross sectional view of a spacer part of a liquid crystal device according to a third embodiment.

FIG. 6 is a diagram showing a liquid crystal device of a comparative example.

FIG. 7 is a plan view showing a schematic configuration of a liquid crystal device according to a fourth embodiment.

FIG. 8 is a cross sectional view taken along the line A-A of the liquid crystal device of FIG. 7.

FIG. 9 is a cross sectional view taken along the line B-B of the liquid crystal device of FIG. 7.

FIG. 10 is a cross sectional view showing a schematic configuration of a pixel part of a liquid crystal device according to a fifth embodiment.

FIG. 11 is a cross sectional view showing a schematic configuration of a pixel part of a liquid crystal device according to a sixth embodiment.

FIG. 12 is a cross sectional view showing a schematic configuration of a pixel part of a liquid crystal device according to a seventh embodiment.

### DESCRIPTION OF EMBODIMENTS

### First Embodiment

A first embodiment of a liquid crystal device and a method of manufacture therefor will be described with reference to the drawings. In addition, in each of the following embodiments, the same reference numerals are given to the same or equivalent parts in the drawings, and the description is cited for the parts of the same reference numerals.

### (Configuration of Liquid Crystal Device 10)

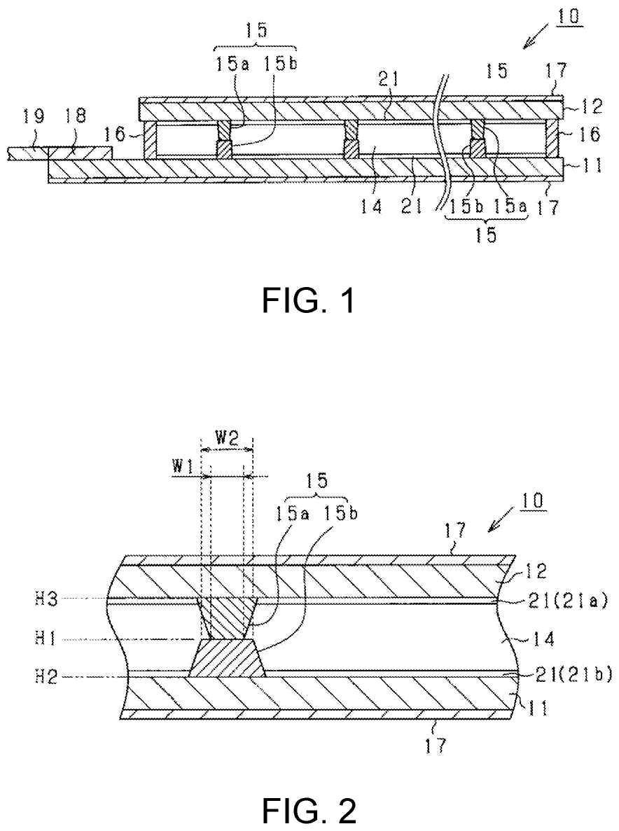

A liquid crystal device 10 of the present embodiment is of a polymer sustained alignment (PSA) mode type and is a liquid crystal display having a flat panel structure in which substrates are formed in a flat shape. A plurality of pixels are arranged in a matrix shape in a display part of the liquid crystal device 10. The liquid crystal device 10 includes a pair of substrates made up of a first substrate 11 and a second substrate 12 and a liquid crystal layer 14 interposed between the pair of substrates as illustrated in FIG. 1.

The first substrate 11 is a TFT substrate, including various types of wiring such as scanning signal lines and video signal lines, a thin film transistor (TFT) as a switching element, a pixel electrode made of a transparent conductor such as indium tin oxide (ITO), and a planarization film (passivation layer) provided on a glass substrate. In addition, the second substrate 12 is a counter substrate, including a color filter, a black matrix as a light shielding layer, a common electrode formed of a transparent conductor such as ITO, and an overcoat layer provided on a glass substrate. A thickness of the glass substrates is arbitrary, but may be, for example, 0.001 to 1.5 mm. In addition, instead of the glass substrate, for example, a transparent substrate such as a transparent plastic substrate may be used. In the present embodiment, no liquid crystal alignment film is formed on surfaces of either the first substrate 11 or the second substrate 12.

The first substrate 11 and the second substrate 12 are arranged to have a predetermined gap (cell gap) therebetween so that an electrode forming surface of the first substrate 11 faces an electrode forming surface of the second substrate 12. The cell gap may be, for example, 1 μm to 5 μm. Circumferential edge parts of the pair of substrates arranged to face each other are bonded to each other via a sealing material 16. As a material of the sealing material 16, a material known as a sealing material for liquid crystal devices (e.g., a heat curable resin or a photo-curable resin) may be used. The space surrounded by the first substrate 11, the second substrate 12, and the sealing material 16 is filled with a liquid crystal composition, and accordingly the liquid crystal layer 14 is arranged adjacent to the first substrate 11 and the second substrate 12. In the present embodiment, the liquid crystal layer 14 is formed using a liquid crystal composition containing photopolymerizable monomers.

The liquid crystal layer 14 has negative dielectric anisotropy. In addition, the liquid crystal layer 14 may have positive dielectric anisotropy. The liquid crystal layer 14 has PSA layers 21, which are polymer layers formed by polymerizing photopolymerizable monomers in the liquid crystal composition, at the respective boundary parts between the liquid crystal layer 14 and the first substrate 11 and the second substrate 12. The PSA layers 21 are formed by photopolymerizing photopolymerizable monomers pre-mixed into the liquid crystal layer 14 in a state in which liquid crystal molecules are pre-tilt aligned after the creation of a liquid crystal cell. In the liquid crystal device 10, initial alignment of the liquid crystal molecules included in the liquid crystal layer 14 is controlled by the PSA layers 21.

First spacers 15a extending toward the first substrate 11 are formed on the electrode forming surface side of the second substrate 12, and second spacers 15b extending toward the second substrate 12 are formed at respective positions facing the first spacers 15a on the surface of the first substrate 11 on the electrode forming surface side. The first spacers 15a are formed to be shorter than the gap between the first substrate 11 and the second substrate 12 in the regions (more specifically, display regions of respective pixels) in which the spacers 15 are not arranged (the first spacers 15a and the second spacers 15b), and keep the distance between the first substrate 11 and the second substrate 12 uniform by being in contact with parts of the outermost surface of the first substrate 11 or members (the second spacers 15b in the present embodiment) formed on the surface of the first substrate 11.

The first spacers 15a and the second spacers 15b are columnar photo-spacers projecting from the surfaces of the respective substrates in the substrate thickness direction, and the plurality of spacers 15 are arranged at positions overlapping with the black matrix when viewed in the thickness direction of the liquid crystal device 10 side by side and having predetermined gaps therebetween. In addition, as a columnar shape, there are a cylindrical shape, a prismatic shape, a tapered shape, and the like, and FIG. 2 shows an example of a tapered shape. As illustrated in FIG. 2, a height position H1 of the tip of each first spacer 15a is different from a height position H2 of the boundary between the liquid crystal layer 14 and the first substrate 11. Each of the first spacer 15a and the second spacer 15b has a height to an intermediate position between the pair of substrates. Specifically, the tip of the first spacer 15a has a sufficient height so as to project from a PSA layer 21a arranged on the second substrate 12, and the tip of the second spacer 15b has a sufficient height so as to project from a PSA layer 21b arranged on the first substrate 11. Accordingly, the first spacer 15a comes in contact with the tip of the second spacer 15b on the first substrate 11 side of the PSA layer 21a, and the second spacer 15b comes in contact with the tip of the first spacer 15a on the second substrate 12 side of the PSA layer 21b.

In addition, “the outermost surface of the first substrate 11” and “the outermost surface of the second substrate 12” refer to the surfaces that are located furthest outwards in the first substrate 11 and the second substrate 12 when arranging the substrates to face each other immediately before the liquid crystal cell is created. For example, in a case where a resin film is formed on the surface of the glass substrate, the outer surface of the resin film corresponds to “the outermost surface of the first substrate 11” or “the outermost surface of the second substrate 12.” However, in a case where a resin film and a spacer 15 are formed on the surface of the glass substrate, the end face of the spacer 15 is not “the outermost surface of the first substrate 11” or “the outermost surface of the second substrate 12,” and the outer surface of the resin film corresponds to “the outermost surface of the first substrate 11” or “the outermost surface of the second substrate 12,” and the spacer 15 corresponds to a “member formed on the surface of the first substrate 11” or “a member formed on the surface of the second substrate 12.”.

The second spacers 15b are formed at positions on the electrode forming surface of the first substrate 11 facing the tip of each of the plurality of first spacers 15a, and the cell gap is formed by the tips of the first spacers 15a and the tips of the second spacers 15b coming in contact with each other. As illustrated in FIG. 1 and FIG. 2, the height position H1 of the tip of the second spacer 15b is higher than the height position H2 of the boundary between the liquid crystal layer 14 and the outermost surface of the first substrate 11 when the liquid crystal device 10 is viewed in the substrate thickness direction from the first substrate 11. In addition, when the liquid crystal device 10 is viewed from the second substrate 12, the height position H1 of the tip of the first spacer 15a is higher than a height position H3 of the boundary between the liquid crystal layer 14 and the outermost surface of the second substrate 12. More specifically, the tips of each of the first spacers 15a and the second spacers 15b are arranged inward from the PSA layers 21 in the liquid crystal layer 14.

As illustrated in FIG. 2, a width W1 of the tip of each first spacer 15a is different from a width W2 of the tip of each second spacer 15b, and the width W2 of the tip of the second spacer 15b is greater. Accordingly, even in a case where stress is applied to the upper and lower substrates and displacement occurs in the horizontal direction, the substrates can be easily held with the end faces of the first spacer 15a and the second spacer 15b coming in contact with each other. The tip of the first spacer 15a and the tip of the second spacer 15b are not fixed (set as free ends), and thus can absorb displacement in the horizontal direction.

In addition, the width W1 may be greater than the width W2. In addition, the width W1 and the width W2 may be set to be equal, and the tip of the first spacer 15a and the tip of the second spacer 15b may be arranged adjacent to each other with an adhesive layer therebetween.

In the liquid crystal device 10, polarizing plates 17 are arranged on the outer sides of the respective first substrate 11 and second substrate 12. A terminal region 18 is provided at an outer edge part of the first substrate 11, and the liquid crystal device 10 is driven by connecting a driver IC 19 for driving a liquid crystal to the terminal region 8.

### (Method of Manufacture for Liquid Crystal Device 10)

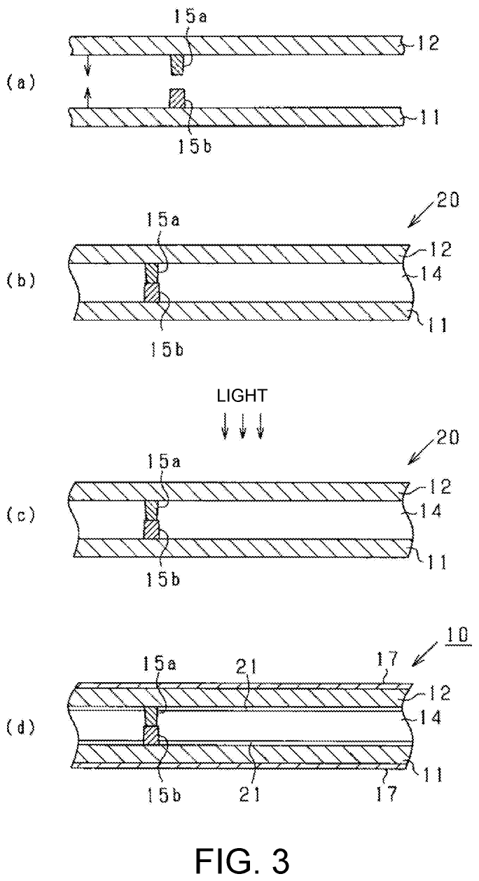

Next, a method of manufacture for the liquid crystal device 10 of the present embodiment will be described using FIG. 3. The present method of manufacture includes the following Step A to Step C.

Step A: A step of forming the first spacer 15a on the second substrate 12 and forming the second spacer 15b on the first substrate 11.

Step B: A step of creating the liquid crystal cell 20 by arranging the first substrate 11 and the second substrate 12 to face each other via a layer formed of a liquid crystal composition including photopolymerizable monomers.

Step C: A step of irradiating the liquid crystal cell 20 with light.

To manufacture the liquid crystal device 10 illustrated in FIG. 1 and FIG. 2, first, a plurality of first spacers 15a are formed on the surface of the second substrate 12 and a plurality of the second spacers 15b are formed on the surface of the first substrate 11 in Step A (see FIG. 3(a)). As a method for forming the spacers 15, for example, a photolithography method, a dispenser method, a screen printing method, or the like is exemplified. Among these, it is preferable to use the photolithography method. A height, a width, and the number of spacers 15 can be appropriately selected according to a size of the substrates, the cell gap, and the like. The first substrate 11 and the second substrate 12 may be cleaned before or after the formation of the spacers 15 using a cleansing solution such as ultrapure water.

Since a known method can be used as the method for forming the spacers 15 using a photolithography method, detailed description is omitted here, however, the formation can be generally performed using a method including a film formation step, an irradiation step, and a development step. First, in the film formation step, a radiation-sensitive resin composition for spacers is coated on the substrates to form a coating film. In a case where a radiation-sensitive resin composition includes a solvent, it is preferable to remove the solvent by pre-baking the coated surface. A known material can be used as the radiation-sensitive resin composition for spacers, and it can be prepared by appropriately selecting a binder polymer, a photopolymerization initiator, a light shielding agent, and the like and mixing them as described in, for example, Japanese Unexamined Patent Application Publication No. 2015-069181. With respect to the type of each component to be blended into the radiation-sensitive resin composition for spacers and a blending proportion, for example, the description of Japanese Unexamined Patent Application Publication No. 2015-069181 can be applied.

In the irradiation step at the time of the formation of the spacers, at least a part of the coating film is irradiated with and exposed to radiation. At the time of exposure, the exposure is performed via a photomask having a predetermined pattern according to the shape of the spacers 15. In addition, with respect to the second spacers 15b, the second spacers 15b may be formed at positions facing the tips of each of the plurality of the first spacers 15a in the state in which the first substrate 11 and the second substrate 12 are arranged to face each other.

Next, the coating film that has been irradiated with the radiation is developed (the development step). Accordingly, an unnecessary part (the irradiated part in case of a positive type) is removed and the plurality of spacers 15 are formed having predetermined gaps therebetween in the direction along the substrate surfaces. As a developing solution, an alkaline aqueous solution is preferable. A heating step of heating the coating film may be included after the development. Due to the heating, the developing solution can be sufficiently removed and a curing reaction of the binder polymer is accelerated if necessary.

Next, in Step B, the first substrate 11 on which the second spacers 15b have been formed and the second substrate 12 on which the first spacers 15a have been formed are arranged such that the spacer forming surfaces thereof face each other (see FIG. 2(a)), and thereby the tips of the first spacers 15a are caused to come into contact with the tips of the second spacers 15b. A layer formed of the liquid crystal composition including photopolymerizable monomers (the liquid crystal layer 14) is interposed between the first substrate 11 and the second substrate 12, and accordingly, the liquid crystal cell 20 is created (see FIG. 2(b)). In the present method for manufacture, a process of forming a liquid crystal alignment film on each surface of the first substrate 11 and the second substrate 12 is not executed.

The liquid crystal layer 14 is formed by dropping or coating a liquid crystal composition on one substrate that has been coated with the seal material 16 and then bonding it to the other substrate. At this time, due to the point that uneven coating of a liquid crystal aligning agent (ODF unevenness) can be satisfactorily mitigated, a method of dropping the liquid crystal composition using a liquid crystal dropping device (one drop filling (ODF) device) such that distances between dropping points of liquid droplets are 3 mm or less or a method of dropping the liquid crystal composition using an inkjet coating device is preferable. In the case of the former, the distances between the dropping points of the liquid droplets are preferably equal to or shorter than 1 mm, more preferably equal to or shorter than 0.8 mm, and particularly preferably equal to or shorter than 0.5 mm. However, a method of forming the liquid crystal layer 14 is not limited to the aforementioned methods, and for example, a method of bonding the circumferential edge parts of the pair of substrates that have been arranged to face each other via the cell gap with the seal material 16, injecting the liquid crystal composition to fill the cell gap surrounded by the substrate surfaces and the seal material 16, and sealing the injection hole may also be employed. It is preferable to remove flow alignment that may occur during the filling with the liquid crystal by heating the liquid crystal cell 20 that has been manufactured as described above to the temperature at which the used liquid crystal has an isotropic phase and then performing an annealing process to gradually cool the liquid crystal cell down to room temperature.

For the photopolymerizable monomers mixed with the liquid crystal composition that is used for forming the liquid crystal layer 14, a compound having two or more (meth)acryloyl groups can be preferably used in terms of high polymerizability with respect to light. It is preferable for the photopolymerizable monomers to have the structure expressed by the following formula (B-I) in the liquid crystal molecules in terms of improvement in the response speed, display characteristics, and long-term reliability of the liquid crystal molecules.

X¹¹—Y¹¹—X¹²— (B-I)

(In the formula (B-I), X¹¹ and X¹² each independently represent a 1,4-phenylene group or a 1,4-cyclohexylene group, and Y¹¹ is a single bond, a divalent hydrocarbon group having 1 to 4 carbon atoms, —COO—CₙH₂ₙ—OCO (n is an integer of 1 to 10), an oxygen atom, a sulfur atom, or —COO—. However, X¹¹ and X¹² may be substituted with one or a plurality of alkyl groups having 1 to 30 carbon atoms, a fluoroalkyl group having 1 to 30 carbon atoms, an alkoxy group having 1 to 30 carbon atoms, a fluoroalkoxy group having 1 to 30 carbon atoms, a fluorine atom, or a cyano group).

It is preferable for the photopolymerizable monomers to have a long chain alkyl structure in a side chain in terms of the response speed and the liquid crystal alignment property of the liquid crystal molecules. As the long chain alkyl structure, any of an alkyl group having 3 to 30 carbon atoms, a fluoroalkyl group having 3 to 30 carbon atoms, an alkoxy group having 3 to 30 carbon atoms, and a fluoroalkoxy group having 3 to 30 carbon atoms is preferable. Among these, a group having 5 or more carbon atoms is preferable and a group having 10 or more carbon atoms is more preferable. It is preferable to adopt a long chain alkyl structure in the photopolymerizable monomers in at least one of X¹¹ and X¹² of the aforementioned formula (B-I).

As specific examples of the photopolymerizable monomers, for example, di(meth)acrylates having a biphenyl structure, di(meth)acrylates having a phenyl-cyclohexyl structure, di(meth)acrylates having a 2,2-diphenylpropane structure, di(meth)acrylates having a diphenylmethane structure, dithio(meth)acrylates having a diphenyl thioether structure, and the like may be exemplified. It is preferable for a blending proportion of the photopolymerizable monomers to be 0.1 to 0.5 mass % with respect to the whole amount of the liquid crystal composition used for the formation of the liquid crystal layer 14. In addition, with respect to the photopolymerizable monomers, one type may be used alone or two or more types may be used in combination.

Next, in Step C, light irradiation is performed on the liquid crystal cell 20 obtained in Step B (see FIG. 3(c)). The light irradiation to the liquid crystal cell 20 may be performed in a state in which no voltage is applied between the electrodes, may be performed in a state in which a predetermined voltage that does not drive the liquid crystal molecules in the liquid crystal layer 14 is applied, or may be performed in a state in which a predetermined voltage that drives the liquid crystal molecules is applied between the electrodes. Preferably, light irradiation is performed in a state in which a voltage is applied to the electrodes of the pair of substrates. The applied voltage can be, for example, a direct current or an alternating current of 5 to 50 V. As light to be irradiated, for example, ultraviolet light and visible light including light having a wavelength of 150 to 800 nm can be used, but ultraviolet light including light having a wavelength of 300 to 400 nm is preferable. Light irradiation may be performed in a direction perpendicular to the substrate surface, a direction oblique to the substrate surface, or in a combination of directions thereof in a case where the radiation to be used is linearly polarized light or partially polarized light. The irradiation direction may be an oblique direction in a case where the irradiation is performed with non-polarized radiation.

As a light source of the light irradiation, for example, a low pressure mercury lamp, a high pressure mercury lamp, a deuterium lamp, a metal halide lamp, an argon resonance lamp, a xenon lamp, an excimer laser, or the like can be used. In addition, a light source of ultraviolet of the preferred wavelength range can be obtained from, for example, a means used together with a filter diffraction grating or the like. The irradiation amount of light is preferably 1,000 to 200,000 J/m² and more preferably 1,000 to 100,000 J/m².

In addition, the liquid crystal device 10 is obtained by bonding the polarizing plates 17 to the outer surfaces of the liquid crystal cell 20 (see FIG. 3(d)). For the polarizing plates 17, a polarizing plate obtained by sandwiching a polarizing film, which is called an “H film” that has absorbed iodine while stretch-aligning polyvinyl alcohol with cellulose acetate protective films, a polarizing plate composed of an H film itself, or the like may be exemplified.

### (Action of Spacers 15)

Next, the action of the spacers 15 will be described. As described above, by constituting the spacers 15 as the first spacers 15a and the second spacers 15b in the liquid crystal device 10, the height position of the tips of the first spacers 15a is set to be different from that of the boundary part between the substrate facing the tips of the first spacers 15a (the first substrate 11) and the liquid crystal layer 14, and the position of the tips of the second spacers 15b is set to be different from the height position of the boundary part between the substrate facing the tips of the second spacer 15b (the second substrate 12) and the liquid crystal layer 14. Thus, even though no liquid crystal alignment film is formed on either of the pair of substrates and even in a configuration in which no control of initial alignment of liquid crystal by a film that has excellent mechanical strength is performed, in a case where displacement occurs in the horizontal direction (the width direction of the liquid crystal device 10) due to stress on the upper and lower substrates, it is possible to mitigate misalignment of the liquid crystal at the boundary parts with the substrates. Accordingly, misalignment can be mitigated, and further a good display quality can be obtained. In addition, the second spacers 15b correspond to “suppressing parts that mitigate misalignment of the liquid crystal layer 14 that is caused by movement of the tips of the first spacers 15a.”

Particularly, since the PSA layers 21 are physically fragile in comparison to liquid crystal alignment films, in a configuration in which the PSA layers 21 are in contact with the tips of the spacers 15 formed on the second substrate 12 (see FIG. 6), when stress is applied to the upper and lower substrates and thus displacement occurs in the horizontal direction, the PSA layers 21 are partially separated due to the displacement of the tips of the spacers 15 in the horizontal direction, and thus there is concern of misalignment. With regard to this problem, the first spacers 15a come in contact with the tips of the second spacers 15b on the first substrate 11 side of the PSA layer 21a and the second spacers 15b come in contact with the tips of the first spacer 15a on the second substrate 12 side of the PSA layer 21b by making the height position of the tips of the spacers 15 different from that of the boundary parts between the substrates facing the tips of the spacers 15 and the liquid crystal layer 14, and thus even in the case where stress is applied to the upper and lower substrates and displacement occurs in the horizontal direction, it is possible to prevent the PSA layers 21 from being separated. Accordingly, it is possible to prevent the PSA layers 21 from being partially separated, and as a result, misalignment can be mitigated.

### Second Embodiment

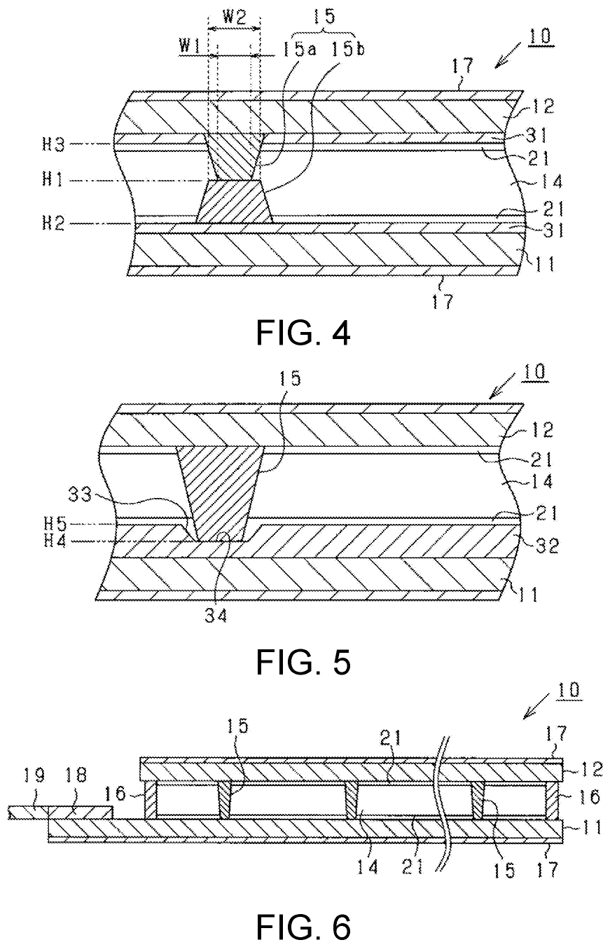

Next, in a second embodiment, differences from the first embodiment will be mainly described. A liquid crystal device 10 of the second embodiment is different from the liquid crystal device 10 of the first embodiment in that, on a liquid crystal layer 14 side of a first substrate 11 and a second substrate 12, layers composed of a water-soluble compound having at least one of a linear alkyl structure having three or more carbon atoms and an alicyclic structure (which will be referred to as “specific structure layers 31” below) are arranged adjacent to the liquid crystal layer 14 (more specifically, adjacent to PSA layers 21) as illustrated in FIG. 4. By providing such specific structure layers 31, stability of initial alignment and a voltage holding ratio can be improved. In addition, in the present specification, water solubility means a property of a material that can be dissolved in pure water at 25° C. by 1 mass % or more, preferably 5 mass % or more, and more preferably 10 mass % or more.

As a water-soluble compound having at least one of a linear alkyl structure having three or more carbon atoms and an alicyclic structure (which will also be referred to as a “water-soluble compound [B]” below), it is preferable to use a compound having at least one type of functional group selected from a group consisting of a vinyl group, an epoxy group, an amino group, a (meth)acryloyl group, a mercapto group, and isocyanate group. Since the compound has such a functional group, it is possible to further boost the improvement effect of the stability of initial alignment and a voltage holding ratio.

In a case where the water-soluble compound [B] has a linear alkyl structure having three or more carbon atoms, the linear alkyl structure preferably has 3 to 40 carbon atoms, and more preferably has 5 to 30 carbon atoms. As specific examples of the linear alkyl structure, an alkanediyl group having 3 to 40 carbon atoms, a divalent group in which —O—, —CO—, —COO—, —NH—, and —NHCO— have been introduced in a carbon-carbon bond of an alkanediyl group, a group in which at least one hydrogen atom of an alkanediyl group is substituted with a fluorine atom, and the like can be exemplified.

In a case where the water-soluble compound [B] has an alicyclic structure, the alicyclic structure may be either monocyclic or polycyclic. As specific examples of the alicyclic structure, a cycloalkane structure having 5 to 20 carbon atoms, a bicycloalkane structure having 7 to 20 carbon atoms, a sterol structure (e.g., a cholestanyl group, a cholesteryl group, a phytosteryl group, etc.), and the like can be exemplified. In addition, the water-soluble compound [B] may have a linear alkyl structure having three or more carbon atoms and a monocyclic or polycyclic alicyclic structure.

For the water-soluble compound [B], for example, a silane coupling agent, an anionic surfactant, a nonionic surfactant, an amphoteric surfactant, a nonionic surfactant, or the like can be exemplified. As specific examples thereof, it is possible to exemplify, as a silane coupling agent, for example, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-triethoxysilylpropyltriethylenetriamine, 10-trimethoxysilyl-1,4,7-triazadecane, 9-trimethoxysilyl-3,6-diazononyl acetate, 9-trimethoxysilyl-3,6-methyl diazanonanoate, N-benzyl-3-aminopropyltrimethoxysilane, N-phenyl-3-aminopropyltrimethoxysilane, glycidoxymethyltrimethoxysilane, 2-glycidoxyethyltrimethoxysilane, 3-glycidoxypropyltrimethoxysilane, dimethyloctadecyl[3-(trimethoxysilyl)propyl]ammonium chloride, 3-(trihydroxysilyl)propyl methacrylate, 1,6-bis(trimethoxysilyl)hexane, 3-(trimethoxysilyl)propyl benzoate, or the like;

as the anionic surfactant, for example, sulfuric ester of a higher alcohol, alkyl benzene sulfonate, aliphatic sulfonate, sulfate ester of polyethylene glycol alkyl ether, or the like;

as the nonionic surfactant, for example, a compound of an alkyl ester type of polyethylene glycol, an alkyl ether type, an alkyl phenyl ether type, or the like; as the amphoteric surfactant, a surfactant containing a carboxylic acid salt, a sulfate ester salt, a sulfonic acid salt, and a phosphate ester salt as an anion part, or a surfactant containing an amine salt and a quaternary ammonium salt as a cation part, specifically, for example, an amino acid type including betaines such as a lauryl betaine, a stearyl betaine, lauryl-β-alanine, stearyl-β-alanine, lauryl di(aminoethyl)glycine, octyl di(aminoethyl)glycine, or the like;

and as nonionic surfactant, a POE cholesterol ether, a POE/POP cholesterol ether, a POE/POP/POB cholesterol ether, a POE/POB cholesterol ether, a POE phytosterol ether, a POE/POP phytosterol ether, a POE phytostanol ether, a POE/POP phytostanol ether (here, POE indicates a polyoxyethylene group, POP indicates a polyoxypropylene group, and POB indicates a polyoxybuthylene group), or the like. In addition, one type of water-soluble compound [B] may be used alone or two or more types thereof can be used in combination.

As the water-soluble compound [B], it is preferable to use at least one type selected from a group consisting of a silane coupling agent, an anionic surfactant, and a nonionic surfactant among the aforementioned components, and it is particularly preferable to use a silane coupling agent or a nonionic surfactant from the viewpoint of the liquid crystal alignment property.

Although a method for forming the specific structure layers 31 is not particularly limited, a method of preparing a solution in which the water-soluble compound [B] is dissolved in a solvent such as water and coating the substrates with the prepared solution and drying it is preferable. A coating method is not particularly limited, and for example, an immersion method, a dipping method, a spin coating method, a brush coating method, a shower method, or the like can be exemplified. Performing the process of forming the specific structure layers 31 as part of a cleaning process for removing foreign substances on the substrates is preferable because it simplifies the step.

Specifically, first, the water-soluble compound [B] is blended with a substrate cleaning solution (for example, ultra-pure water), then the cleaning solution is coated on at least the electrode forming surface of the substrate and thereby coating films are formed. In addition, the substrate cleaning process (the formation process of the specific structure layers 31) may be performed before the spacer formation step or after the spacer formation step. A blending proportion of the water-soluble compound [B] in the cleaning solution is preferably 5 mass % or lower, preferably 0.1 to 2.5 mass %, and more preferably 0.5 to 1 mass %. Immersing the substrate into the cleaning solution is preferable from the viewpoint of cleaning efficiency. An immersion time may be, for example, 5 minutes to 2 hours. Then, by performing heating or drying using air if necessary, the substrate on which a thin film composed of the water-soluble compound [B] has been formed is obtained.

In addition, in the second embodiment, the specific structure layer 31 may be formed only on one of the first substrate and the second substrate.

### Third Embodiment

Next, in a third embodiment, differences from the first embodiment will be mainly described. In the present embodiment, a resin layer without a liquid crystal alignment function is formed on a first substrate 11, and the height position of the tip of each spacer 15 formed on a second substrate 12 is set to be different from the height position of the boundary between a liquid crystal layer 14 and the first substrate 11 by bringing the tip of the spacer 15 formed on the second substrate 12 in contact with a recess part provided in the resin layer. Accordingly, misalignment of the liquid crystal layer 14 caused by movement of the tip of the spacer 15 can be mitigated.

Specifically, the columnar spacer 15 is formed on the electrode forming surface of the second substrate 12 using, for example, the photolithography method as illustrated in FIG. 5. A resin layer 32 is formed on the first substrate 11 as an insulating planarization film, and the resin layer 32 is adjacent to the liquid crystal layer 14. A thickness of the resin layer 32 is, for example, 0.01 μm to 1 μm.

Recess parts 33 are formed at positions on the resin layer 32 facing the tips of the plurality of respective spacers 15 that are formed on the second substrate 12. The spacers 15 are formed to be longer than the gap between the first substrate 11 and the second substrate 12 in the arrangement regions of the spacers 15. The tips of the respective spacers 15 are fitted into the recess parts 33 at the facing positions and come in contact with bottoms 34 of the recess parts 33. Accordingly, the end faces of the tips of the spacers 15 abut the bottoms 34, and thus a cell gap is kept between the pair of substrates. When the first substrate 11 is set as a reference, a height position H4 of the tip of each spacer 15 with respect to the reference is set to be lower than a height position H5 of the boundary between the liquid crystal layer 14 and the outermost surface of the first substrate 11 as illustrated in FIG. 5. More specifically, the recess part 33 is in contact with the tip of the spacer 15 on the first substrate 11 side of the PSA layer 21. Accordingly, the PSA layers 21 on the surfaces of the substrates facing each other are not separated when the tip of the spacer 15 moves in the horizontal direction. In addition, in the present embodiment, the recess parts 33 correspond to “suppressing parts that mitigate misalignment of the liquid crystal layer 14 that is caused by movement of the tips of the spacers 15.”

To manufacture the liquid crystal device 10 illustrated in FIG. 5, first, a plurality of spacers 15 are formed on the surface of the second substrate 12. Since a method of forming the spacers 15 is basically the same as in the first embodiment, description thereof will be omitted here. Next, the resin layer 32 is formed on the surface of the first substrate 11.

It is preferably to form the resin layer 32 in the photolithography method using a radiation-sensitive resin composition containing a photosensitive resin. The recess parts 33 of the resin layer 32 can be formed in the photolithography method using, for example, a halftone mask. The halftone mask performs intermediate exposure using a translucent film. Three exposure levels of an “exposed part,” an “intermediate exposed part,” and a “non-exposed part” can be expressed in one exposure, and the resin layer 32 having a plurality of types of thickness can be formed after development. With respect to the “intermediate exposed part,” since exposure can be performed with a plurality of gradations by adjusting an amount of light passing or penetrating through the layer, three or more exposure levels can be expressed in one exposure.

In a case where a positive type photosensitive resin is exposed, for example, by performing a development process on the resin layer 32 that has been exposed using the halftone mask, the exposed part that has changed to be soluble in a developing solution is removed and the non-exposed part remains. Here, since only the upper layer part of the resin layer 32 corresponding to the translucent region is exposed, only the upper layer part is removed in the development process and the recess parts 33 are formed. As a radiation-sensitive resin composition for forming the resin layer 32, a composition to be used in formation of a planarization film or an interlayer insulating film can be used, and for example, a radiation-sensitive resin composition disclosed in Japanese Patent Unexamined Application Publication No. 2013-029862, No. 2010-217306, or No. 2016-151744, or the like can be used. In addition, the resin layer 32 is not limited to the positive type, and it is also possible to form the recess parts 33 by applying the photolithography method using the halftone mask to a negative type.

Next, a liquid crystal cell 20 is created by arranging the first substrate 11 and the second substrate 12 to face each other via the liquid crystal layer 14 containing photopolymerizable monomers so that the bottoms 34 on the inner sides of the recess parts 33 formed on the resin layer 32 come in contact with the tips of the spacers 15 formed on the surface of the second substrate 12. Then, the liquid crystal cell 20 is irradiated with light. The description of the first embodiment is applied to details of the creation and light irradiation of the liquid crystal cell 20.

In addition, in the third embodiment, without providing the resin layer 32 on the entire surface of the substrate, the resin layer 32 may be provided in only partial regions including the positions facing the tips of the plurality of respective spacers 15 formed on the second substrate 12. In addition, the specific structure layer 31 may be provided only on at least one of the pair of substrates of the liquid crystal device 10. It is preferable to provide the specific structure layers 31 described in the second embodiment on the first substrate 11 and the second substrate 12 from the viewpoint of a voltage holding ratio and an alignment property.

### Fourth Embodiment

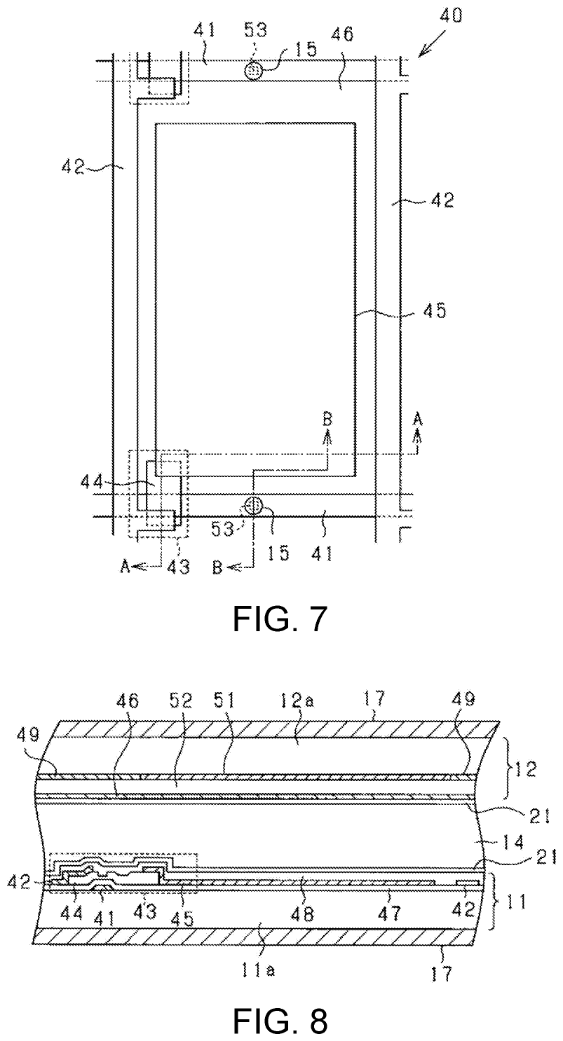

A schematic configuration of a liquid crystal device 10 according to a fourth embodiment will be described using FIGS. 7 to 9. Although the recess parts 33 are provided as suppressing parts at the positions facing the tips of the plurality of respective spacers 15 formed on the surface of the second substrate 12 on the liquid crystal layer 14 side in the above-described third embodiment, projecting parts projecting in the direction facing the second substrate may be provided instead of the recess parts 33. Also in this case, the height position of the tip of each spacer 15 formed on the second substrate 12 can be different from the height position of the boundary between the liquid crystal layer 14 and the first substrate 11.

The liquid crystal device 10 is a PSA mode type liquid crystal display device. The liquid crystal device 10 has a display part and a plurality of pixels 40 are arranged in a matrix shape on the display part. The pixels 40 are formed in a region surrounded by scanning signal lines 41 and video signal lines 42 intersecting each other as illustrated in FIG. 7. In each pixel 40, a thin film transistor 43 is arranged as a switching element. The thin film transistor 43 has a semiconductor layer 44 extending across a scanning signal line 41, one end of the semiconductor layer 44 is connected to a video signal line 42, and the other end thereof is connected to a pixel electrode 45. The pixel electrode 45 has a planar shape. In addition, a shape of the pixel electrode 45 is not limited to the planar shape, and for example, may be a shape in which a plurality of slits (elongated rectangular openings) are provided in a planar electrode. The pixel electrode 45 may be formed of a transparent conductor such as ITO.

The first substrate 11 that is the TFT substrate has a glass substrate 11a, the thin film transistor 43, the scanning signal line 41, the video signal line 42, an insulating layer 47 composed of an inorganic insulating layer such as a silicon oxide layer, the pixel electrode 45, and a passivation layer 48 as illustrated in FIG. 8. The passivation layer 48 has both functions of a protective layer and a planarization layer and is formed using, for example, a silicon oxide layer or a silicon nitride layer. In addition, although an inverted staggered type transistor is exemplified as the thin film transistor 43 in the present embodiment, the embodiment is not limited thereto, and for example, may adopt a staggered type.

The thin film transistor 43 includes the scanning signal line 41 functioning as a gate electrode, the insulating layer 47 functioning as a gate insulating layer, the semiconductor layer 44 formed of silicon (Si), the video signal line 42 functioning as a source (or drain) electrode, and the pixel electrode 45 functioning as a drain (or source) electrode. The thin film transistor 43 is created using a known method such as photolithography. As a specific material for forming each member, known materials can be used. The present embodiment is the same as the above-described embodiments in that no liquid crystal alignment film is formed on the first substrate 11.

The second substrate 12 that is the counter substrate includes a glass substrate 12a, a black matrix 49, a color filter 51, an overcoat layer 52 serving as an insulating layer, and a common electrode 46. The color filter 51 includes subpixels colored with red (R), green (G), and blue (B). The black matrix 49 and the color filter 51 are produced using a known method such as photolithography. This embodiment is the same as the above-described embodiments in that no liquid crystal alignment film is formed on the second substrate 12. The common electrode 46 is a planar electrode formed of a transparent conductor such as ITO and is provided over a plurality of pixels 40.

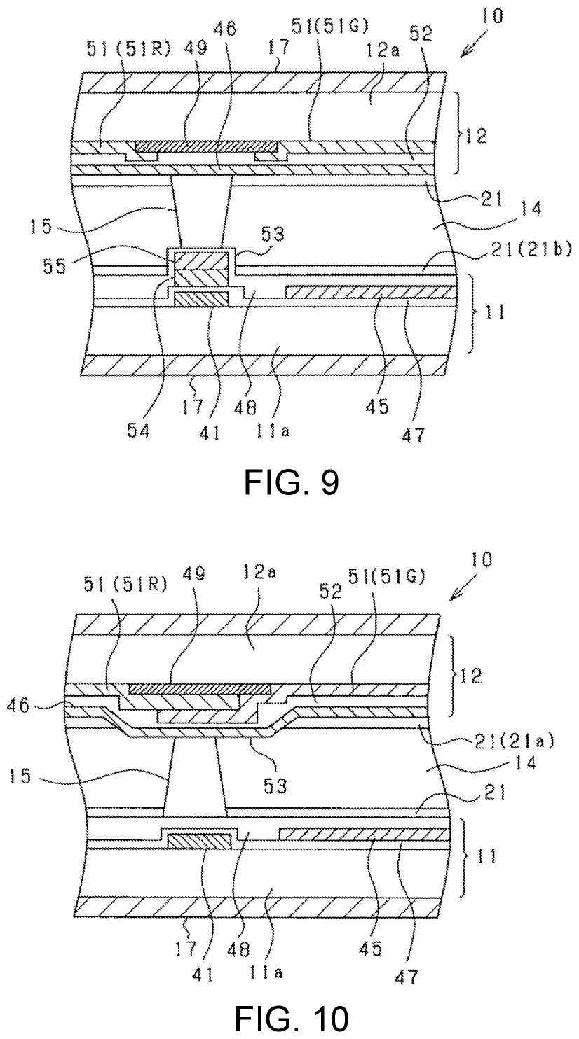

The columnar spacers 15 extending toward the first substrate 11 are formed on the surface of the common electrode 46 on the liquid crystal layer 14 side (see FIG. 9). The spacers 15 are arranged at positions overlapping with the black matrixes 49 when viewed in the thickness direction of the liquid crystal device 10.

In the first substrate 11, a projecting part 53 extending toward the second substrate 12 is provided at a position facing the spacers 15 on the surface of the insulating layer 47 on the liquid crystal layer 14 side as illustrated in FIG. 9. The projecting part 53 is constituted by a lower layer part 54 formed on the surface of the insulating layer 47 on the liquid crystal layer 14 side and an upper layer part 55 laminated on the surface of the lower layer part 54 on the liquid crystal layer 14 side, and is provided at the position overlapping with the scanning signal line 41 when viewed in the thickness direction of the liquid crystal device 10. The lower layer part 54 is formed of the same material as the semiconductor layer 44, and the upper layer part 55 is formed of the same material as the source electrode or the drain electrode. The lower layer part 54 is formed in the same step as that for the semiconductor layer 44, and the upper layer part 55 is formed in the same step as that for the source electrode or the drain electrode. The upper layer part 55 has the surface on the liquid crystal layer 14 side covered by the passivation layer 48, and the scanning signal line 41, the insulating layer 47, the passivation layer 48, the lower layer part 54, and the upper layer part 55 are laminated on the glass substrate 11a in this order and thereby form the projecting part 53.

The projecting part 53 has a tip that is formed to project toward the second substrate 12 side of a PSA layer 21b and is in contact with the tip of the spacer 15. By bringing the tip of the spacer 15 in contact with the tip of the projecting part 53, the height position of the tip of the spacer 15 is set to be different from that of the boundary part between the first substrate 11 and the liquid crystal layer 14, and thus the tip of the spacer 15 is positioned on the second substrate 12 side of the PSA layer 21b. Accordingly, it is possible to prevent the PSA layer 21 from being partially separated due to movement of the spacer 15 in the width direction.

### Fifth Embodiment

A schematic configuration of a liquid crystal device 10 according to a fifth embodiment will be described using FIG. 10. The liquid crystal device 10 of the present embodiment is different from that of the fourth embodiment in that spacers 15 are formed on a first substrate 11 and projecting parts 53 are formed on a second substrate 12 using a laminated body of a black matrix 49 and a color filter 51.

In the liquid crystal device 10 of FIG. 10, the spacer 15 is formed at a position overlapping with the scanning signal line 41 on the first substrate 11 when viewed in the thickness direction of the liquid crystal device 10. In a case where the first substrate 11 is arranged to face the second substrate 12, the spacer 15 is arranged such that the spacer 15 is at a position overlapping with the black matrix 49. The projecting part 53 in a multilayer structure in which a red color filter 51R, a green color filter 51G, an overcoat layer 52, and a common electrode 46 are laminated in this order is formed on the surface of the black matrix 49 arranged to face the spacer 15 on the second substrate 12.

The projecting part 53 has a tip that is formed to project toward the first substrate 11 side of a PSA layer 21a and is in contact with the tip of the spacer 15. By bringing the tip of the spacer 15 in contact with the tip of the projecting part 53, the height position of the tip of the spacer 15 is set to be different from that of the boundary part between the second substrate 12 and the liquid crystal layer 14, and thus the tip of the spacer 15 is positioned on the first substrate 11 side of the PSA layer 21a. Accordingly, it is possible to prevent the PSA layer 21a from being partially separated even if the spacer 15 moves in the width direction.

In addition, although the projecting part 53 is formed by laminating the black matrix 49 and the color filter 51, the projecting part 53 may be formed of a single layer of the black matrix 49 by increasing the thickness of the black matrix 49. In addition, although the color filter 51 is formed by laminating two layers, it may be formed by laminating only one layer or three or more layers on the black matrix 49.

### Sixth Embodiment

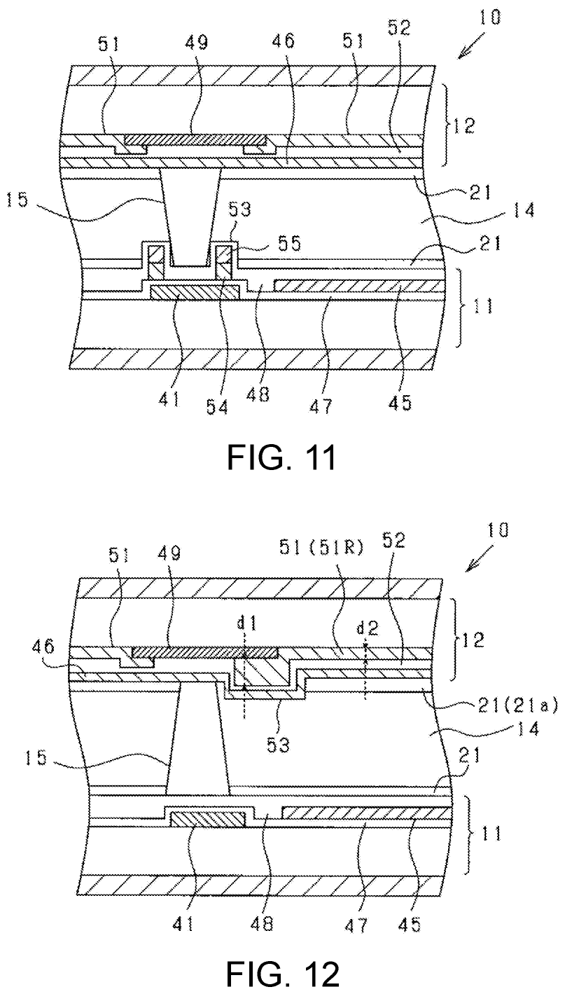

A schematic configuration of a liquid crystal device 10 according to a sixth embodiment will be described using FIG. 11. The liquid crystal device 10 of the present embodiment is different from that of the fourth embodiment in that spacers 15 are formed in the same length as the gap between a first substrate 11 and a second substrate 12 in regions in which the spacers 15 are not arranged and projecting parts 53 are provided on outer circumferential sides of the tips of the spacers 15.

In the liquid crystal device 10 of FIG. 11, the spacer 15 extends toward the first substrate 11, and the tip thereof is in contact with the first substrate 11 (more specifically, a passivation layer 48). The projecting part 53 arranged to surround the outer circumference of the spacer 15 is provided on the surface of the insulating layer 47 on a liquid crystal layer 14 side on the first substrate 11. The projecting part 53 is formed in a ring shape to surround the outer circumference of the spacer 15 and provided around the tip of the spacers 15. In the present embodiment, at least a part of the projecting part 53 is in contact with the outer circumference of the spacer 15. However, the projecting part 53 and the spacer 15 may not be in contact with each other. The projecting part 53 is formed by laminating a lower layer part 54 and an upper layer part 55 and covering a surface of the laminated body with the passivation layer 48 as in the fourth embodiment.

In the steps for manufacturing the liquid crystal device 10, a liquid crystal cell 20 is created by inserting the tip of the spacer 15 into the region surrounded by the inner circumferential edge part of the projecting part 53 when the first substrate 11 and the second substrate 12 are arranged to face each other. Accordingly, movement of the spacer 15 in the width direction is regulated by the projecting part 53, and thus partial separation of the PSA layer 21 caused by the movement of the tip of the spacer 15 can be prevented.

### Seventh Embodiment

A schematic configuration of a liquid crystal device 10 according to a seventh embodiment will be described using FIG. 12. The liquid crystal device 10 of the present embodiment is different from that of the sixth embodiment in that a spacer 15 is formed on a first substrate 11 and a projecting part 53 is formed with a laminated body of a black matrix 49 and a color filter 51 on a second substrate 12.

In the liquid crystal device 10 of FIG. 12, the spacer 15 extends toward the second substrate 12, and the tip thereof is in contact with the second substrate 12 (more specifically, a common electrode 46). The projecting part 53 extending toward the first substrate 11 is provided on the second substrate 12 on an outer circumference of the tip of the spacer 15. In the present embodiment, the projecting part 53 is formed by laminating a green color filter 51G on the surface of the black matrix 49 on the liquid crystal layer 14 side in a predetermined thickness d1 and covering the color filter 51G on the liquid crystal layer 14 side with an overcoat layer 52 and a common electrode 46. The thickness d1 is set to be greater than a thickness d2 of the color filter 51G in the display region of each pixel 40 (specifically, the region in which the color filter 51 is arranged but the black matrix 49 is not arranged). The projecting part 53 may be formed such that the tip thereof projects toward the first substrate 11 beyond a PSA layer 21a.

When the liquid crystal cell 20 is to be created in the steps for manufacturing the liquid crystal device 10, the first substrate 11 and the second substrate 12 are arranged to face each other such that the tip of the spacer 15 comes in contact with the second substrate 12 and the projecting part 53 is arranged on the outer circumference of the tip of the spacer 15. Accordingly, movement of the spacer 15 is regulated by the projecting part 53 and thus partial separation of the PSA layer 21a can be prevented.

In addition, the number of projecting parts 53 is not particularly limited in the liquid crystal device 10 of FIG. 12, and two or more projecting parts may be provided on the outer circumference of the spacer 15 in the circumferential direction.

### OTHER EMBODIMENTS

Although the case where the liquid crystal device is applied to a flat display has been described in the first embodiment to the third embodiment, it may be a liquid crystal display having a curved panel structure in which the first substrate 11 and the second substrate 12 have a curved surface shape. A curved panel is generally manufactured by creating a liquid crystal cell by bonding a pair of substrates to each other with a liquid crystal layer interposed between the substrates and then bending the liquid crystal cell. However, when a liquid crystal cell is bent to manufacture a curved display, displacement occurs between the upper and lower substrates in the horizontal direction due to external stress applied to the substrates in the horizontal direction, the displacement causes the tips of the spacers 15 to move in the horizontal direction and rub the PSA layer 21, which causes separation of the PSA layer 21, and as a result there is concern of misalignment. Thus, by applying the present invention to the curved display, it is possible to prevent the PSA layer 21 from being separated which is caused by bending the liquid crystal cell during a manufacturing step and prevent a decrease in product yield and image quality.

In case of curved display, as the spacers 15, it is preferable to use so-called black column spacers with a light blocking property given from a light blocking agent such as carbon black. Liquid crystal panels in complicated shapes such as a curved display easily have light leakage resulting from displacement of substrates at their bent end parts, however, such black column spacers are preferable because they can sufficiently prevent such light leakage.

Although the contact surfaces of the first spacer 15a and the second spacer 15b may be flat as illustrated in FIG. 4 in the first embodiment and the second embodiment, a shape of the contact surfaces is not particularly limited, and may be, for example, an uneven shape.

The liquid crystal device 10 of the present invention described above in detail can be effectively applied to various applications, and can also be used in various kinds of display devices and light control devices of, for example, watches, portable game machines, word processors, notebook type personal computers, car navigation systems, camcorders, PDAs, digital cameras, mobile telephones, smartphones, various types of monitors, liquid crystal televisions, information displays, and the like.

### EXAMPLES

The present invention will be described in examples below in more detail, but the present invention is not limited to the examples.

### <Preparation of Liquid Crystal Composition>

A liquid crystal composition LC1 was obtained by adding 0.15 mass % of a photopolymerizable compound indicated by the following formula (L1-1) to 10 g of nematic liquid crystal having negative dielectric anisotropy (MLC-6608 manufactured by Merck & Co., Inc.) and mixing them.

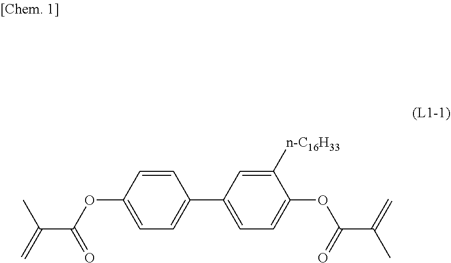

### <Manufacture and Evaluation of Liquid Crystal Device>

### Example 1

### (1) Manufacture of PSA Mode Liquid Crystal Cell

A pair of substrates having conductive films formed of ITO electrodes were prepared on surfaces of two respective glass substrates. In addition, planar electrodes having no slits were used as electrodes. A resin layer 32 having recess parts 33 as illustrated in FIG. 5 was formed on the electrode forming surface of one substrate (a TFT substrate) among the pair of substrates using a photolithography method, and columnar spacers were formed on the electrode forming surface on the other substrate (a counter substrate) using the photolithography method. The recess parts 33 of the resin layer 32 were formed to match the positions of the spacers on the counter substrate when the two substrates are bonded. Then, without going through the step of forming a liquid crystal alignment film, an epoxy resin adhesive containing aluminum oxide balls having a diameter of 3.5 μm was applied to the outer edge of the electrode forming surface of one substrate, then the electrode forming surfaces of both substrates were overlapped so as to face each other and joined with pressure, and the adhesive was hardened. At this time, the pair of substrates were arranged to face each other so that the tips of the spacers abutted the bottoms 34 of the recess parts 33 of the resin layer 32 formed on the other substrate (see FIG. 5).

Next, the gap between the pair of substrates was filled with the liquid crystal composition LC1 prepared as described above from a liquid crystal inlet, the liquid crystal inlet was sealed with an acryl-based photocurable adhesive, an annealing process was performed, and thereby a liquid crystal cell was manufactured. Then, a rectangular wave voltage having a frequency of 60 Hz was applied between conductive films of the liquid crystal cell at an effective value of 10 V, the substrates were irradiated (1.0 J/cm²) with non-polarized ultraviolet light (0.33 mW/cm²) in the normal line direction for 50 minutes with the liquid crystal being driven, and thereby polymerization of monomers was performed. As the light source, “Black light FHF-32BLB” manufactured by Toshiba Lighting & Technology Corporation) was used. FHF-32BLB is an ultraviolet light source having small emission intensity at 310 nm and large emission intensity at 330 nm or higher. In addition, the irradiation amount is the value measured at the reference of a wavelength of 365 nm using a light meter.

### (2) Measurement of Voltage Holding Ratio (VHR)

A voltage holding ratio of a liquid crystal cell obtained in (1) described above was measured. The voltage holding ratio was determined by applying a pulse voltage of 1 V thereto and checking holding of charge for 16.61 milliseconds under the condition of 70° C. For the measurement device, a liquid crystal physical property evaluation system 6254 type manufactured by Toyo Corporation was used. As a result, the voltage holding ratio was 97.3% in this Example.

### (3) Evaluation of Liquid Crystal Alignment Property

The liquid crystal alignment property of the liquid crystal cell obtained in (1) above was evaluated by visually observing it through a crossed nicol prism after the UV irradiation. As a result, the pixel part of the liquid crystal cell displayed substantially completely black after the UV irradiation, the liquid crystal molecules were vertically aligned on the entire surfaces, and no alignment defect was observed.

### (4) Measurement of Separation (Torsion) of PSA (Separation Tolerance Test of PSA Layer)

As evaluation of the separation tolerance of the PSA layer of the liquid crystal cell obtained in (1) above, alignment defects after application of external stress were observed. Specifically, a rod-like indenter having a diameter of 5 mm was pushed at a weight of 2.0 Kgf and a rotation speed of 200 rpm for 10 minutes, and then the number of alignment defect spots at which light leakage that had occurred in pixels was counted under the condition of the crossed nicol prism. As a result, the number of alignment defect spots was 0 in the liquid crystal cell of Example 1 and separation of the PSA layer was not discovered even after the application of stress.

It is found from the above-described result that even a liquid crystal display device without a liquid crystal alignment film shows a high VHR and a favorable alignment state by adding polymerizable monomers to the liquid crystal and forming a PSA layer. In addition, it is clarified that tolerance against the problem of misalignment that occurs when the PSA layer is partially separated due to external stress can be obtained by arranging the resin layer 32 on one substrate and causing the recess parts 33 of the resin layer 32 to abut the tips of the spacers on the counter substrate side.

### Example 2

### (1) Manufacture of PSA Mode Liquid Crystal Cell

A pair of substrates having conductive films formed of ITO electrodes were prepared on the surfaces of two respective glass substrates. In addition, similar electrodes to those of Example 1 were used as electrodes. Spacers illustrated in FIG. 1 and FIG. 2 (the first spacers 15a and the second spacers 15b) were formed on the electrode forming surfaces of one substrate (a TFT substrate) and the other substrate (a counter substrate) of the pair of substrates using the photolithography method. The spacers were formed such that the positions of the second spacer 15b on the TFT substrate match the positions of the first spacers 15a on the counter substrate when the two substrates are bonded. Then, without going through the step of forming a liquid crystal alignment film, an epoxy resin adhesive containing aluminum oxide balls having a diameter of 3.5 μm was applied to the outer edge of the electrode forming surface of the one substrate, and then the liquid crystal composition LC1 was dropped onto the TFT substrate using an ODF device. In addition, and a distance D between adjacent drops of the liquid crystal droplets was about 3 mm, which was a distance between dropped points of droplets in normal ODF. Next, both electrode forming surfaces were overlapped to face each other and joined with pressure, an annealing process was performed thereon, the adhesive was hardened, and thereby a liquid crystal cell was manufactured. At this time, the pair of substrates were arranged to face each other so that the tips of the first spacers 15a abut the tips of the second spacers 15b (see FIGS. 1 and 2).

Then, a rectangular wave voltage having a frequency of 60 Hz was applied between the conductive films of the liquid crystal cell at an effective value of 10 V, the substrates were irradiated (1.0 J/cm²) with non-polarized ultraviolet light (0.33 mW/cm²) in the normal line direction for 50 minutes with the liquid crystal being driven, and thereby polymerization of monomers was performed. A similar light source to that of Example 1 was used.

### (2) Evaluation

The measurement of a VHR, the evaluation of the liquid crystal alignment property, and a separation tolerance test for the PSA layer were performed using the obtained liquid crystal cell under similar conditions to those of Example 1. As a result, the VHR was 97.5%, and for the liquid crystal alignment property, vertical alignment was observed on the entire surfaces as in Example 1. In addition, the number of alignment defect spots after the application of stress was 0, and separation tolerance of the PSA layer was favorable.

### Example 3

A PSA mode liquid crystal display device was manufactured similarly to that of Example 2 except that the electrode forming surface of a counter substrate among a pair of substrates were cleaned using an aqueous solution of 1 mass % of the compound indicated by the following formula (2) after spacers were formed and a specific structure layers 31 was formed on the electrode forming surface (see FIG. 4). In addition, using the manufactured liquid crystal display device, the measurement of a VHR, the evaluation of the liquid crystal alignment property, and a separation tolerance test of the PSA layer were performed under similar conditions to those of Example 1. As a result, the VHR was 99.8%, and for the liquid crystal alignment property, vertical alignment was observed on the entire surfaces as in Example 1. In addition, the number of alignment defect spots after the application of stress was 0, and separation tolerance of the PSA layer was favorable. It is found from the above result that the voltage holding ratio was further improved by processing of the surfaces of the substrates with the water-soluble compound (B).

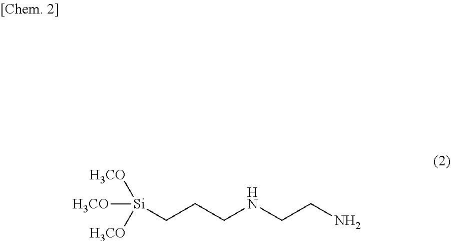 [SMILES: CO[Si](CCCNCCN)(OC)OC]

### (Evaluation of ODF Unevenness)

An AC voltage having a frequency of 60 Hz was applied to the liquid crystal display device of Example 3 at 2.5 V, and unevenness (ODF unevenness) that was occurring in the entire liquid crystal display device was observed. As a result of evaluating the case where unevenness did not occur as “excellent (⊚),” the case where slight unevenness was visually recognized at at least one of a liquid crystal drop position and the middle of liquid crystal drop positions as “good (∘),” ad a case where significant unevenness was visually recognized at at least one of a liquid crystal drop position and the middle of liquid crystal drop positions as “not good (Δ),” the liquid crystal display device of Example 3 was “good (∘).”.

### Comparative Example 1

A pair of substrates having conductive films formed of ITO electrodes were prepared on the surfaces of two respective glass substrates. In addition, similar electrodes to those of Example 1 were used as electrodes. Columnar spacers were formed on the electrode forming surface of one substrate among the pair of substrates using the photolithography method. Then, without going through the step of forming a liquid crystal alignment film, an epoxy resin adhesive containing aluminum oxide balls having a diameter of 3.5 μm was applied to the outer edge of the electrode forming surface of one substrate, the substrates were overlapped such that the mutual electrode forming surfaces face each other and joined with pressure, and the adhesive was hardened.

Next, after the gap between the pair of substrates was filled with the liquid crystal composition LC1 prepared as described above from a liquid crystal inlet, the liquid crystal inlet was sealed with an acryl-based photocurable adhesive, an annealing process was performed, and thereby the liquid crystal cell illustrated in FIG. 6 was manufactured. Then, a rectangular wave voltage having a frequency of 60 Hz was applied between conductive films of the liquid crystal cell at an effective value of 10 V, the substrates were irradiated (1.0 J/cm²) with non-polarized ultraviolet light (0.33 mW/cm²) in the normal line direction for 50 minutes with the liquid crystal being driven, and thereby polymerization of monomers was performed. A similar light source to that of Example 1 was used.

### (2) Evaluation

Using the obtained liquid crystal cell of FIG. 6, the measurement of a VHR, the evaluation of the liquid crystal alignment property, and a separation tolerance test of the PSA layer were performed under similar conditions to those of Example 1. As a result, the VHR was 97.1%, and for the liquid crystal alignment property, vertical alignment was observed on the entire surfaces as in Example 1. However, the number of alignment defect spots after the application of stress was 18, and separation tolerance of the PSA layer was inferior to that in Examples 1 to 3.

The evaluation results of the liquid crystal cells of Examples 1 to 3 and Comparative example 1 are shown in Table 1 below.

TABLE 1

| | | | Evaluation | | |
|---|---|---|---|---|---|
| | | | | | The number |
| | | | | | of alignment |
| | | | | | defect spots |
| | Cell structure | | | | after |
| | Spacer | Surface | VHR | Alignment | application |
| | structure | processing | [%] | property | of stress |
| Example 1 | Recess | — | 97.3 | Vertical | 0 |
| | structure + | | | alignment | |
| | spacers on | | | on entire | |
| | counter | | | surface | |
| | substrate | | | | |
| Example 2 | Spacers on | — | 97.5 | Vertical | 0 |
| | both | | | alignment | |
| | substrates | | | on entire | |
| | | | | surface | |
| Example 3 | Spacers on | Processing | 99.8 | Vertical | |
| | both | with | | alignment | 0 |
| | substrates | water-soluble | | on entire | |
| | | compound | | surface | |
| Comparative | Spacers on | — | 97.1 | Vertical | 18 |
| example 1 | counter | | | alignment | |
| | substrate | | | on entire | |
| | | | | surface | |

It is apparent from the above results that, in Example 1 in which the tips of the spacers formed on the one substrate abutted the recess parts of the resin layer formed on the other substrate and Examples 2 and 3 in which the spacer members formed on each of the pair of substrates abutted each other, excellent results were shown in all evaluation items. On the other hand, in Comparative example 1 in which the tips of the spacers formed on the one substrate abutted the surface of the other substrate at the boundary parts between the liquid crystal layer and the substrates, separation tolerance of the PSA layer was inferior to that in Examples. In addition, Example 3 in which the substrate surface processing was performed using the water-soluble compound (B) showed the result of a higher voltage holding ratio.

### Example 4

A PSA mode liquid crystal display device having such spacers illustrated in FIG. 4 was manufactured and the measurement of a VHR, the evaluation of the liquid crystal alignment property, and a separation tolerance test of the PSA layer were performed under similar conditions to those of Example 3 except that the counter substrate was cleaned using an aqueous solution of 3-(trihydroxysilyl)propyl methacrylate (silane coupling agent) having a concentration of 0.05 mass %. As a result, the VHR was 99.7%, and for the liquid crystal alignment property, vertical alignment was observed on the entire surfaces as in Example 1. In addition, the number of alignment defect spots after the application of stress was 0, and separation tolerance of the PSA layer was favorable. In addition, a PSA mode liquid crystal display device was manufactured under similar conditions except that the structure illustrated in FIG. 5 was adopted as the structure of the liquid crystal display device, and as a result of performing the various kinds of evaluation, similar results were obtained.

### Example 5

A liquid crystal display device was manufactured by performing similar operations as in Example 3 except that an adhesive was applied to the outer edge part of the TFT substrate and then the liquid crystal composition LC1 was dropped onto the TFT substrate at equal intervals using an inkjet device (IJ-6021 manufactured by Shibaura Mechatronics Corporation), then the electrode forming surface of the TFT substrate was overlapped with the electrode forming surface of the counter substrate to face each other and joined with pressure, and the adhesive was hardened, and ODF unevenness was evaluated. As a result, the result was “excellent (⊚)” in this Example.

### Example 6

A liquid crystal display device was manufactured by performing similar operations as in Example 3 except that an adhesive was applied to the outer edge part of the TFT substrate and then the liquid crystal composition LC1 was dropped onto the TFT substrate at equal intervals using an ODF device such that the distance between adjacent drops of the liquid crystal droplets is within 0.5 mm, then the electrode forming surface of the TFT substrate was overlapped with the electrode forming surface of the counter substrate to face each other and joined with pressure, and the adhesive was hardened, and ODF unevenness was evaluated. As a result, the result was “excellent (⊚)” in this Example.

It was found from the results of Examples 5 and 6 that ODF unevenness could be sufficiently prevented in the cases where the liquid crystal device was manufactured by using the inkjet device or such that the distance between adjacent drops of the liquid droplets was set to be within 0.5 mm using the ODF device in comparison to Example 3.

### Example 7

### (1) Manufacture of PSA Mode Liquid Crystal Cell

Columnar spacers as illustrated in FIG. 9 were formed on the electrode forming surface of the glass substrate (a counter substrate) having a transparent conductive film formed of an ITO electrode using the photolithography method. In addition, aside from this, a TFT substrate having a transparent conductive film formed of an ITO electrode was prepared. With respect to the TFT substrate, a convex structure was formed by arranging a semiconductor layer (the lower layer part 54) in a region different from the TFT element formation spot and laminating a metal (an Al alloy) layer (the upper layer part 55) on the semiconductor layer in the course of forming the TFT semiconductor layer.

Then, without going through the step of forming a liquid crystal alignment film, an epoxy resin adhesive containing aluminum oxide balls having a diameter of 3.5 μm was applied to the outer edge of the electrode forming surface of one substrate, the substrates were overlapped such that the mutual electrode forming surfaces face each other and joined with pressure, and the adhesive was hardened. At this time, the pair of substrates were arranged to face each other so that the tip faces of the spacers on the counter substrate abutted the tip face of the convex structure on the TFT substrate (see FIG. 9).

Next, after the gap between the pair of substrates was filled with the liquid crystal composition LC1 prepared as described above from a liquid crystal inlet, the liquid crystal inlet was sealed with an acryl-based photocurable adhesive, an annealing process was performed, and thereby the liquid crystal cell was manufactured. Then, a rectangular wave voltage having a frequency of 60 Hz was applied between the conductive films of the liquid crystal cell at an effective value of 10 V, the substrates were irradiated (1.0 J/cm²) with non-polarized ultraviolet light (0.33 mW/cm²) in the normal line direction for 50 minutes with the liquid crystal being driven, and thereby polymerization of monomers was performed. A similar light source to that of Example 1 was used.

### (2) Evaluation

Using the obtained liquid crystal cell, the measurement of a VHR, the evaluation of the liquid crystal alignment property, and a separation tolerance test of the PSA layer were performed under similar conditions to those of Example 1. As a result, the VHR was 97.2%, and for the liquid crystal alignment property, vertical alignment was observed on the entire surfaces as in Example 1. In addition, the number of alignment defect spots after the application of stress was 0, and separation tolerance of the PSA layer was favorable.

### Example 8

### (1) Manufacture of PSA Mode Liquid Crystal Cell

Columnar spacers as illustrated in FIG. 10 were formed on the electrode forming surface of the TFT substrate having a transparent conductive film formed of an ITO electrode using the photolithography method. In addition, aside from this, a counter substrate having a transparent conductive film formed of an ITO electrode was prepared. A black matrix, color filters of each color, and a common electrode were prepared on the counter substrate, and a convex structure was formed on the black matrix by overlapping the black matrix, the red color filter, and the green color filter in the course of forming the color filters.

Then, without going through the step of forming a liquid crystal alignment film, an epoxy resin adhesive containing aluminum oxide balls having a diameter of 3.5 μm was applied to the outer edge of the electrode forming surface of one substrate, the substrates were overlapped such that the mutual electrode forming surfaces face each other and joined with pressure, and the adhesive was hardened. At this time, the pair of substrates were arranged to face each other so that the end faces of the spacers on the TFT substrate abutted the convex structure on the counter substrate (see FIG. 10).

Next, after the gap between the pair of substrates was filled with the liquid crystal composition LC1 prepared as described above from a liquid crystal inlet, the liquid crystal inlet was sealed with an acryl-based photocurable adhesive, an annealing process was performed, and thereby the liquid crystal cell was manufactured. Then, a rectangular wave voltage having a frequency of 60 Hz was applied between the conductive films of the liquid crystal cell at an effective value of 10 V, the substrates were irradiated (1.0 J/cm²) with non-polarized ultraviolet light (0.33 mW/cm²) in the normal line direction for 50 minutes with the liquid crystal being driven, and thereby polymerization of monomers was performed. A similar light source to that of Example 1 was used.

### (2) Evaluation

Using the obtained liquid crystal cell, the measurement of a VHR, the evaluation of the liquid crystal alignment property, and a separation tolerance test of the PSA layer were performed under similar conditions to those of Example 1. As a result, the VHR was 96.9%, and for the liquid crystal alignment property, vertical alignment was observed on the entire surfaces as in Example 1. In addition, the number of alignment defect spots after the application of stress was 0, and separation tolerance of the PSA layer was favorable.

### Example 9

### (1) Manufacture of PSA Mode Liquid Crystal Cell

Columnar spacers as illustrated in FIG. 11 were formed on the electrode forming surface of the counter substrate having a transparent conductive film formed of an ITO electrode using the photolithography method. In addition, aside from this, a TFT substrate having a transparent conductive film formed of an ITO electrode was prepared. With respect to the TFT substrate, a ring-shaped convex structure was formed by arranging a semiconductor layer (the lower layer part 54) in a region different from the TFT element formation spot and laminating a metal (an Al alloy) layer (the upper layer part 55) on the semiconductor layer in the course of forming the TFT semiconductor layer. The spacers on the counter substrate and the convex structure on the TFT substrate are formed to have the positional relation that, when the two substrates are bonded, the convex structure is arranged on the outer circumference of the tips of the spacers and the end faces of the spacers abut the TFT substrate.

Then, without going through the step of forming a liquid crystal alignment film, an epoxy resin adhesive containing aluminum oxide balls having a diameter of 3.5 μm was applied to the outer edge of the electrode forming surface of one substrate, the substrates were overlapped such that the mutual electrode forming surfaces face each other and joined with pressure, and the adhesive was hardened. At this time, the pair of substrates were arranged to face each other so that the spacers on the counter substrate abut the concave structure on the TFT substrate (see FIG. 11).

Next, after the gap between the pair of substrates was filled with the liquid crystal composition LC1 prepared as described above from a liquid crystal inlet, the liquid crystal inlet was sealed with an acryl-based photocurable adhesive, an annealing process was performed, and thereby the liquid crystal cell was manufactured.

Then, a rectangular wave voltage having a frequency of 60 Hz was applied between the conductive films of the liquid crystal cell at an effective value of 10 V, the substrates were irradiated (1.0 J/cm²) with non-polarized ultraviolet light (0.33 mW/cm²) in the normal line direction for 50 minutes with the liquid crystal being driven, and thereby polymerization of monomers was performed. A similar light source to that of Example 1 was used.

### (2) Evaluation

Using the obtained liquid crystal cell, the measurement of a VHR, the evaluation of the liquid crystal alignment property, and a separation tolerance test of the PSA layer were performed under similar conditions to those of Example 1. As a result, the VHR was 97.0%, and for the liquid crystal alignment property, vertical alignment was observed on the entire surfaces as in Example 1. In addition, the number of alignment defect spots after the application of stress was 0, and separation tolerance of the PSA layer was favorable.

### Example 10

### (1) Manufacture of PSA Mode Liquid Crystal Cell

Columnar spacers as illustrated in FIG. 12 were formed on the electrode forming surface of the TFT substrate having a transparent conductive film formed of an ITO electrode using the photolithography method. In addition, aside from this, a counter substrate having a transparent conductive film formed of an ITO electrode was prepared. A black matrix, color filters of each color, and a common electrode were prepared on the counter substrate, and a convex structure was formed on the black matrix by overlapping the red color filter with the black matrix in the course of forming the color filters. The spacers on the TFT substrate and the convex structure on the counter substrate were formed respectively to have the positional relation that a side surface of the convex structure is in contact with the outer circumference of the tips of the spacers.

Then, without going through the step of forming a liquid crystal alignment film, an epoxy resin adhesive containing aluminum oxide balls having a diameter of 3.5 μm was applied to the outer edge of the electrode forming surface of one substrate, the substrates were overlapped such that the mutual electrode forming surfaces face each other and joined with pressure, and the adhesive was hardened. At this time, the pair of substrates were arranged to face each other so that the spacers on the TFT substrate come in contact with the convex structure on the counter substrate (see FIG. 12).

Next, after the gap between the pair of substrates was filled with the liquid crystal composition LC1 prepared as described above from a liquid crystal inlet, the liquid crystal inlet was sealed with an acryl-based photocurable adhesive, an annealing process was performed, and thereby the liquid crystal cell was manufactured. Then, a rectangular wave voltage having a frequency of 60 Hz was applied between the conductive films of the liquid crystal cell at an effective value of 10 V, the substrates were irradiated (1.0 J/cm²) with non-polarized ultraviolet light (0.33 mW/cm²) in the normal line direction for 50 minutes with the liquid crystal being driven, and thereby polymerization of monomers was performed. A similar light source to that of Example 1 was used.

### (2) Evaluation

Using the obtained liquid crystal cell, the measurement of a VHR, the evaluation of the liquid crystal alignment property, and a separation tolerance test of the PSA layer were performed under similar conditions to those of Example 1. As a result, the VHR was 96.8%, and for the liquid crystal alignment property, vertical alignment was observed on the entire surfaces as in Example 1. In addition, the number of alignment defect spots after the application of stress was 0, and separation tolerance of the PSA layer was favorable.

### <Evaluation of Afterimage Characteristics (Burn-in Characteristics)>

Two liquid crystal cells of each of the above-described examples (Examples 1 to 8 and Comparative example 1) were prepared, and external stress was applied to the liquid crystal cells using the same method as in the “(4) Measurement of separation (torsion) of PSA” of Example 1. Then, the two liquid crystal cells were placed under the environment at the temperature of 25° C. and 1 barometric pressure, and a combined voltage of 3.5 V of an AC voltage and 5 V of a DC voltage was applied to one of them (the other one is a reference) for two hours. Immediately thereafter, 4 V of an AC voltage of was applied thereto. The time from the point at which the application of 4 V of the AC voltage was started to the point at which it was not possible to visually recognize the difference in optical transparency from the reference was measured. The case where the time was shorter than 50 seconds was evaluated as “excellent (⊚),” the case where the time was longer than or equal to 50 seconds and shorter than 100 seconds was evaluated as “good (◯)” afterimage characteristics, the case where the time was longer than or equal to 100 seconds and shorter than 150 seconds was evaluated as a “allowable (Δ)” afterimage characteristic, and the case where the time exceeds 150 seconds was evaluated as a “not good (X)” afterimage characteristic. As a result, while Comparative example was evaluated as “not good,” all the Examples 1 to 8 were evaluated as “good.” It is apparent from the results that, according to the present embodiment, a liquid crystal device having excellent afterimage characteristics can be obtained even without a liquid crystal alignment film.

Although the present disclosure has been described on the basis of embodiments, it is understood that the present disclosure is not limited to the above embodiments and structures. The present disclosure also includes modification made within the ranges of various modified examples and equivalent thereto. In addition, it is understood that not only various combinations and forms but also other combinations and forms further including only one element or more or less of the aforementioned combinations and forms come within the scope and the idea of the present disclosure.

### REFERENCE SIGNS LIST

10 Liquid crystal device
11 First substrate
12 Second substrate
14 Liquid crystal layer
15 Spacer
15a First spacer
15b Second spacer
20 Liquid crystal cell
21 (21a, 21b) PSA layer
31 Specific structure layer
32 Resin layer
33 Recess part
53 Projecting part

1. A liquid crystal device comprising:
a pair of substrates comprising a first substrate and a second substrate arranged to face each other;
and a liquid crystal layer interposed between the first substrate and the second substrate,
wherein a liquid crystal alignment film is not formed on both the first substrate and the second substrate,
wherein a spacer extending toward the first substrate is formed on the second substrate, and
wherein a suppressing part mitigating misalignment of the liquid crystal layer caused by movement of a tip of the spacer is provided on the first substrate.

2. The liquid crystal device according to claim 1, wherein the liquid crystal layer is formed using a liquid crystal composition containing photopolymerizable monomers and has a polymer layer obtained by polymerizing the photopolymerizable monomers at a boundary part with respect to each of the pair of substrates.

3. The liquid crystal device according to claim 1,
wherein the spacer is formed to be shorter or longer than a gap between the first substrate and the second substrate in a region in which the spacer is not arranged, and
wherein the suppressing part is provided at a position on the first substrate facing the spacer and in contact with the tip of the spacer.

4. The liquid crystal device according to claim 3,
wherein the liquid crystal layer is formed using a liquid crystal composition containing photopolymerizable monomers and has a polymer layer obtained by polymerizing the photopolymerizable monomers at a boundary part with respect to each of the pair of substrates, and
wherein the suppressing part is in contact with the tip of the spacer on the second substrate side or the first substrate side of the polymer layer.

5. The liquid crystal device according to claim 3,
wherein a spacer formed on the second substrate is set as a first spacer,
wherein the suppressing part is formed at the position on the first substrate facing the first spacer and is a second spacer extending toward the second substrate, and
wherein a cell gap is formed by bringing a tip of the first spacer in contact with a tip of the second spacer.

6. The liquid crystal device according to claim 5, wherein a width of the first spacer is set to be different from a width of the second spacer at a contact part between the first spacer and the second spacer.

7. The liquid crystal device according to claim 3,
wherein the first substrate is a TFT substrate,
wherein the second substrate is a counter substrate that is arranged to face the TFT substrate,
wherein the suppressing part is a projecting part projecting in the direction facing the counter substrate,
wherein a cell gap is formed by bringing a tip of the projecting part in contact with the tip of the spacer, and
wherein the projecting part is formed using the same material as a material constituting at least one type selected from a group consisting of a thin film transistor, a pixel electrode, wiring, and an insulating layer included in the TFT substrate.

8. The liquid crystal device according to claim 3,
wherein the second substrate is a TFT substrate,
wherein the first substrate is a counter substrate that is arranged to face the TFT substrate and has a light shielding layer and a color filter layer,
wherein the suppressing part is a projecting part projecting in the direction facing the TFT substrate,
wherein a cell gap is formed by bringing a tip of the projecting part in contact with the tip of the spacer, and
wherein the projecting part is formed of a laminated body of the light shielding layer and the color filter layer or the light shielding layer.

9. The liquid crystal device according to claim 3,
wherein a resin layer not having a liquid crystal aligning capability is formed on the first substrate,
wherein the suppressing part is a recess part formed at a position on the resin layer facing the spacer to be recessed to the side opposite to the direction facing the second substrate, and
wherein a cell gap is formed by bringing a bottom of the recess part in contact with the tip of the spacer.

10. The liquid crystal device according to claim 1,
wherein the spacer is formed to have the same length as a gap between the first substrate and the second substrate in a region in which the spacer is not arranged, and
wherein the suppressing part is a projecting part arranged on the first substrate on an outer circumferential side of the spacer and projecting toward the counter substrate.

11. The liquid crystal device according to claim 10,
wherein the first substrate is a TFT substrate,
wherein the second substrate is a counter substrate arranged to face the TFT substrate, and
wherein the projecting part is formed using the same material as a material constituting at least one type selected from a group consisting of a thin film transistor, a pixel electrode, wiring, and an insulating layer included in the TFT substrate.

12. The liquid crystal device according to claim 10,
wherein the second substrate is a TFT substrate,
wherein the first substrate is a counter substrate arranged to face the TFT substrate and has a light shielding layer and a color filter layer, and
wherein the projecting part is formed of a laminated body of the light shielding layer and the color filter layer or the light shielding layer.

13. The liquid crystal device according to claim 1, wherein a layer composed of a water-soluble compound [B] having at least one of a linear alkyl structure having three or more carbon atoms and an alicyclic structure is formed on the liquid crystal layer side of at least one of the first substrate and the second substrate.

14. The liquid crystal device according to claim 13, wherein, the water-soluble compound [B] comprises a compound having at least one type of functional group selected from a group consisting of a vinyl group, an epoxy group, an amino group, a (meth)acryloyl group, a mercapto group, and an isocyanate group.

15. The liquid crystal device according to claim 1, wherein the liquid crystal layer has negative dielectric anisotropy.

16. A method of manufacture for a liquid crystal device including a pair of substrates made up of a first substrate and a second substrate arranged to face each other and a liquid crystal layer interposed between the first substrate and the second substrate, not having a liquid crystal alignment film formed on both the first substrate and the second substrate, the method comprising:
a step of forming a spacer extending away from a surface of the second substrate on the second substrate;
a step of forming a suppressing part mitigating misalignment of the liquid crystal layer on the first substrate, which is caused by movement of a tip of the spacer in the liquid crystal device;
a step of creating a liquid crystal cell by arranging the first substrate and the second substrate to face each other via a layer of a liquid crystal composition containing photopolymerizable monomers so that the movement of the spacer is restricted by the suppressing part; and
a step of irradiating the liquid crystal cell with light.

17. The method of manufacture for a liquid crystal device according to claim 16, further comprising:
a step of forming a layer composed of a water-soluble compound [B] having at least one of a linear alkyl structure having three or more carbon atoms and a monocyclic or polycyclic alicyclic structure on at least one of the first substrate and the second substrate.

18. The method of manufacture for a liquid crystal device according to claim 16, further comprising:
a step of dropping the liquid crystal composition on one of the first substrate and the second substrate using an inkjet coating device.

19. The method of manufacture for a liquid crystal device according to claim 16, further comprising:
a step of dropping the liquid crystal composition on one of the first substrate and the second substrate using a liquid crystal dropping device such that the distance between dropping points of droplets is 3 mm or less.
